(19) United States
(12) Patent Application Publication
(10) Pub. No.: US 2026/0364725 A1
(43) Pub. Date: Nov. 19, 2026

(54) COMPACT DOVETAIL CLAMP

(71) Applicant: David Allen Bishop, Brookfield, NH (US)

(72) Inventor: David Allen Bishop, Brookfield, NH (US)

(21) Appl. No.: 19/677,142

(22) Filed: May 14, 2026

Related U.S. Application Data
(60) Provisional application No. 63/805,714, filed on May 14, 2025.

(51) Int. Cl. B23Q 3/06

(52) U.S. Cl. CPC B23Q 3/06

(57) ABSTRACT

A compact dovetail clamp for CNC machine platforms, T-slot tables, and grid plates is disclosed. The clamp comprises a clamp base mountable to a machine platform via a mounting screw, an upper slide coupled through a downward-angled dovetail track, and a drive screw that advances the upper slide to simultaneously apply lateral and downward force on a workpiece. Each foot-pound of drive screw torque generates at least approximately 150 pounds of clamping force over a ¼ inch travel range. The clamp is scalable across screw sizes; larger sizes generate forces sufficient to exceed cutting forces at maximum machine speeds and feeds. The machinable clamp face may be serrated, smooth, or contoured. A retaining clip retracts the upper slide upon loosening. A chip shield protects internal components from debris. The clamp rotates 360 degrees about its mounting point. The mounting and drive screws share a common hex drive for single-tool operation.

### CROSS-REFERENCE TO RELATED APPLICATION

This non-provisional patent application claims priority to and the benefit of U.S. Provisional Patent Application No. 63/805,714, filed May 14, 2025, entitled “Compact Dovetail Clamp,” the entire disclosure of which is incorporated herein by reference in its entirety.

### FIELD OF THE INVENTION

The present invention relates generally to work holding devices for machining operations, and more particularly to a compact, modular dovetail clamp configured to secure workpieces on CNC machine platforms, T-slot tables, and grid plates with high clamping force, a low profile, and flexible orientation.

### BACKGROUND OF THE INVENTION

In the field of CNC woodworking and machining, effective workholding solutions are essential for achieving precision, repeatability, and safety. Conventional clamping devices commonly used in this space include toggle clamps, step clamps, and standard machinist vises. These systems, while serviceable in some contexts, are often not optimized for compact CNC machines or smaller workspaces.

Many existing clamping solutions rely on top-down pressure applied directly to the workpiece surface, which may interfere with cutting tool paths. This configuration can require operators to interrupt machining operations to reposition clamps around features that cannot be accessed due to clamp placement. Additionally, having to reposition clamps may require the operator to re-establish the datum position—a time-consuming and error-prone process that increases the risk of part scrapping and tooling damage.

Clamps with flat or unmodulated contact surfaces can mar finished workpiece surfaces or fail to adequately grip irregular or raw material surfaces. When a clamp fails to adequately grip a workpiece, the workpiece may shift during machining, resulting in wasted material, broken tooling, and increased machine downtime. These deficiencies affect the quality of the final product and lead to inefficiencies in workflow.

The need for versatility, strength, and precision in a compact form factor is particularly pronounced for operators working within constrained environments. Existing solutions typically require multiple tools for setup and adjustment, further complicating operations for machinists and educators. Clamps offering some degree of advanced functionality tend to be bulky, expensive, or incompatible with grid plate and T-slot systems commonly used in smaller CNC machines.

Furthermore, most existing modular clamping devices do not provide meaningful downward force on a workpiece. Instead, they rely primarily on lateral or top-mounted pressure, which does not adequately resist the vertical forces imparted by rotating cutting tools. Without a downward clamping component, workpieces can lift off the machine table, leading to inaccurate cuts and potentially unsafe conditions.

Therefore, a need exists for improved workholding systems and methods that address these and other challenges with conventional clamping devices. The present invention satisfies these and other needs.

### SUMMARY OF THE INVENTION

The present invention provides a compact dovetail clamp designed for use with CNC machine platforms, T-slot tables, grid plates, and other machining fixtures. In one aspect, the invention provides a workholding device comprising a clamp base, an upper slide movably coupled to the clamp base through a dovetail connection, and a drive screw configured to advance the upper slide along the dovetail connection to apply clamping force to a workpiece.

In one embodiment, the dovetail connection includes a precision downward-angled track formed in the clamp base such that advancement of the drive screw causes the upper slide to travel both downward and laterally, thereby simultaneously applying downward force against the machine table and lateral clamping force against the workpiece. This dual-axis force generation provides secure, stable workpiece retention with minimal applied torque. In one embodiment, each foot-pound of torque applied to the drive screw generates at least approximately 150 pounds of clamping force.

In another aspect, the clamp face of the upper slide is machinable and may be provided in a serrated configuration for gripping raw or rough materials, a smooth configuration for clamping finished components without marring, or a contoured configuration machined to match the geometry of a particular workpiece. In yet another aspect, the compact dovetail clamp is configured to rotate about its mounting point, allowing clamping force to be applied in any direction across the machine platform.

In another aspect, the mounting screw and the drive screw are configured to be actuated by the same tool, such as a common hex key, enabling single-tool installation and operation. The clamp further includes a chip shield configured to cover the mounting screw and protect the dovetail interface from chip contamination during machining operations.

These and other features, aspects, and advantages of the present invention will become better understood with reference to the following drawings, description, and claims.

### BRIEF DESCRIPTION OF THE DRAWINGS

The accompanying drawings, which are incorporated in and constitute a part of this specification, illustrate preferred embodiments of the invention and together with the description serve to explain the principles of the invention. Like reference numerals refer to corresponding parts throughout the several views.

FIG. 1 is a cross-sectional view of a preferred embodiment of the compact dovetail clamp of the present invention, showing the assembled clamp in a clamped position;

FIG. 2 is a cross-sectional view of the compact dovetail clamp of FIG. 1, showing the chip shield in an open or retracted position to expose the mounting screw;

FIG. 3 is a cross-sectional view of the compact dovetail clamp illustrating the range of clamp travel of the upper slide along the dovetail track;

FIG. 4 is a perspective view of a compact dovetail clamp showing a serrated face configuration of the clamp face;

FIG. 5 is a perspective view of a compact dovetail clamp showing a smooth face configuration of the clamp face, wherein the serrated face has been skim cut to produce a non-marring surface;

FIG. 6 is a perspective view of a compact dovetail clamp showing a contoured face configuration of the clamp face, wherein the face has been machined to match the geometry of a workpiece;

FIG. 7 is a perspective and cross-sectional detail view of the drive screw assembly, illustrating the drive screw and the retaining clip, wherein the retaining clip is configured to retract the upper slide when the drive screw is loosened;

FIG. 8 is a set of perspective, top, front, and cross-sectional views of a compact dovetail clamp of the present invention, showing the serrated clamp face configuration of the upper slide;

FIG. 9 is a perspective view illustrating a smooth face configuration of the upper slide, wherein the serrated face has been skim cut to produce a non-marring surface;

FIG. 10 is a top view of a grid plate or T-slot plate configured for use with the compact dovetail clamp of the present invention, showing the plate apertures and T-slot features; and

FIG. 11 is a perspective view illustrating a pair of compact dovetail clamps positioned on opposing sides of workpiece A, sandwiching the workpiece to provide bilateral clamping force and downward retention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various modifications, equivalents, and alternatives will become apparent to those skilled in the art without departing from the spirit and scope of the invention as set forth in the claims.

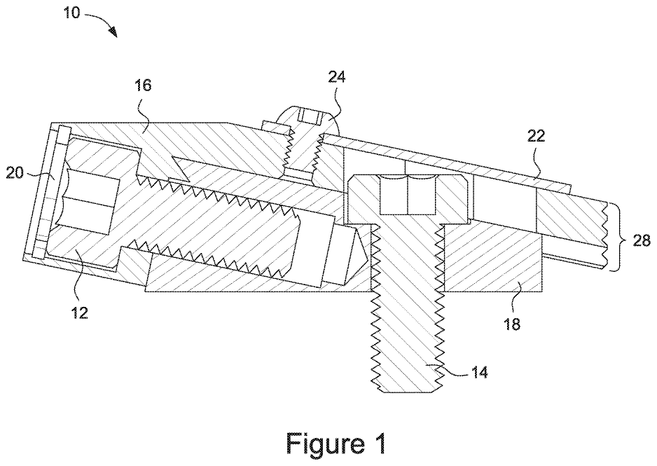

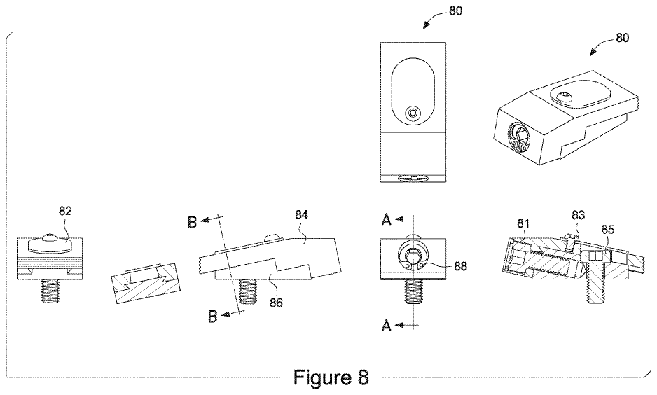

Referring now to the drawings, wherein like reference numerals designate identical or corresponding parts throughout the several views, FIG. 1-11 illustrate preferred embodiments of a compact dovetail clamp constructed in accordance with the present invention.

### Overall Assembly

As shown in FIG. 1-11, the compact dovetail clamp comprises a clamp base 18 configured to be mounted on a machine platform such as a T-slot table or grid plate. The clamp base 18 includes a precision downward-angled dovetail track that interfaces with an upper slide 16 through a dovetail connection. The angled geometry of the track and dovetail connection allows linear torque applied through a drive screw 12 to produce a simultaneous downward and lateral clamping force on a workpiece. This dual-axis force is a significant operational advantage of the present invention over conventional top-down or purely lateral clamping devices.

In a preferred embodiment, the clamp base 18, upper slide 16, and associated structural components are fabricated from 7075-T6 aluminum alloy, which provides a high strength-to-weight ratio suitable for both desktop and light-duty industrial CNC applications. For applications requiring greater strength and resistance to deformation under heavy cutting forces, the components may alternatively be fabricated from steel or heat-treated alloys.

The clamp base 18 may further include a front surface configured to function as a hard stop or locator, enabling precise and repeatable placement of workpieces against a fixed datum. This locating feature is particularly advantageous in production environments requiring consistent, repeatable workpiece positioning.

### Drive Screw 12 and Upper Slide 16

The drive screw 12 is actuated by applying torque to a torque-applying feature, such as a hex drive socket. The drive screw 12 may be provided in a range of sizes to suit the intended application. In one embodiment configured for desktop and light-duty CNC machines, the drive screw 12 is an M6 fastener. In embodiments configured for larger industrial CNC machines, the drive screw 12 may be an M12 or M16 fastener, or other sizes as appropriate. The hex drive of the drive screw 12 is, in one embodiment, of the same size and configuration as the hex interface used to actuate the mounting screw 14, enabling the operator to install and operate the clamp with a single hex key or hex-bit driver. As the drive screw 12 is advanced, it urges the upper slide 16 downward and forward along the angled dovetail track of the clamp base 18, applying compressive and downward force to the workpiece resting on the machine platform.

The clamping force generated by the compact dovetail clamp scales with drive screw size. In one embodiment, each foot-pound of torque applied to the drive screw 12 generates at least approximately 150 pounds of clamping force. In an embodiment using an M6 drive screw 12, the operating torque is, in one embodiment, approximately 5 ft-lbs (6.5 N·m), and is, in one embodiment, not to exceed approximately 10 ft-lbs (13.5 N·m) when the clamp is used on a grid plate. In embodiments utilizing larger drive screw sizes, such as M12 or M16, correspondingly greater clamping forces are achievable, as further described in the Materials and Variations section below.

The range of clamp travel 34 is shown in FIG. 3 and represents the axial displacement available between the fully retracted and fully advanced positions of the upper slide 16. In a preferred embodiment, the range of clamp travel 34 is approximately ¼ inch (approximately 6.5 mm). This range provides the operator with flexibility to accommodate workpieces having varying dimensions and tolerances without requiring repositioning of the clamp base 18.

### Mounting Screw 14

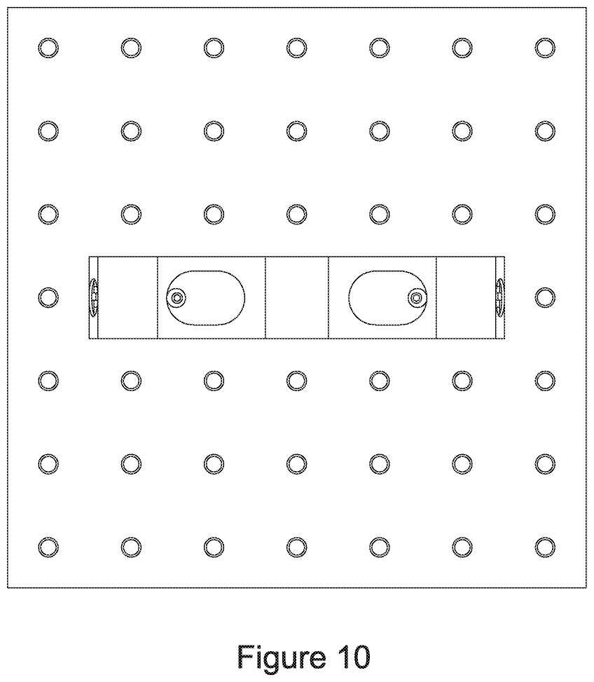

The mounting screw 14 secures the clamp base 18 to the machine platform. The mounting screw 14 passes through the clamp base 18 and engages a T-slot 41 in a T-slot plate or a threaded aperture in a grid plate (shown in FIG. 10). The mounting screw 14 may be provided in a range of sizes corresponding to the drive screw 12 size and the intended application. In one embodiment configured for desktop and light-duty use, the mounting screw 14 is an M6 fastener; in embodiments configured for larger industrial CNC machines, the mounting screw 14 may be an M12 or M16 fastener, or other sizes as appropriate. The clamp base 18 is configured to rotate about the mounting screw 14, providing 360-degree rotational adjustability so that clamping force may be applied in any direction across the machine platform without removing or reinstalling the clamp.

### Retaining Clip 20

As illustrated in FIG. 7, the drive screw 12 includes a retaining clip 20 associated therewith. The retaining clip 20 is configured such that when the drive screw 12 is loosened or retracted, the retaining clip 20 positively engages the upper slide 16 and draws the upper slide 16 rearward along the dovetail track. This feature ensures that the upper slide 16 retracts in a controlled manner when clamping force is released, rather than relying solely on gravity or manual repositioning, and facilitates rapid workpiece loading and unloading.

### Chip Shield 22 and Chip Shield Retaining Plug 24

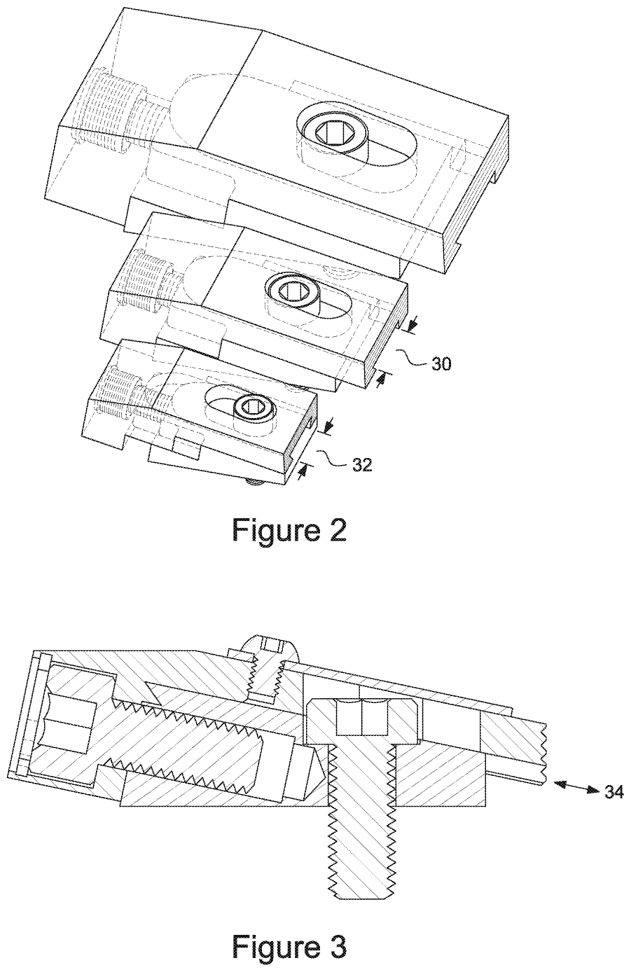

The compact dovetail clamp further includes a chip shield 22 and a chip shield retaining plug 24, as shown in FIGS. 1 and 2. The chip shield 22 is pivotally mounted to the clamp base 18 and configured to be rotated to cover the mounting screw 14 after the clamp is secured to the machine platform. In the closed position, the chip shield 22 protects the dovetail interface and internal drive components from chip contamination, coolant, and debris generated during machining operations. This feature helps maintain smooth and consistent actuation of the drive screw 12 over extended periods of use.

The chip shield retaining plug 24 engages the chip shield 22 to retain it in the closed position during machining. When the operator wishes to access the mounting screw 14, the chip shield 22 may be pivoted to the open position as shown in FIG. 2.

### Clamp Face 28 and Face Configurations

Affixed to or integrally formed on the clamping face of the upper slide 16 is a clamp face 28. The clamp face 28 may be provided in several configurations depending on the workholding requirements of the application.

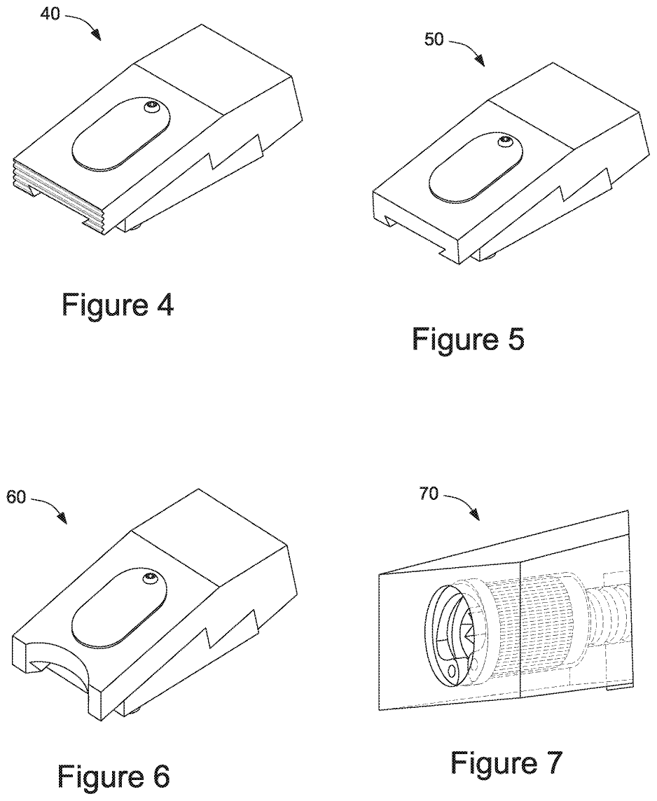

In one configuration, identified by reference numeral 40 in FIG. 4, the clamp face 28 is provided with a serrated face 40. The serrations provide enhanced grip on raw or rough workpiece surfaces, including steel, aluminum, plastic, and wood, and are particularly advantageous when clamping workpieces that have not yet been finish-machined. The serrated face 40 substantially increases frictional engagement with the workpiece, resisting both lateral displacement and vertical lift-off during machining.

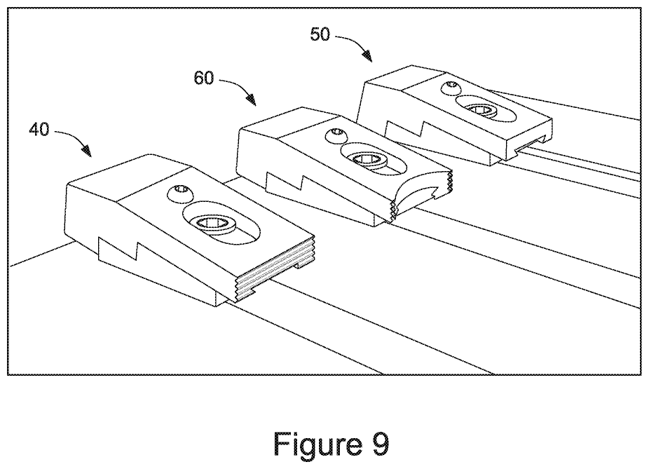

In another configuration, identified by reference numeral 50 in FIGS. 5 and 9, the clamp face 28 may be skim cut to produce a smooth face 50. The smooth face 50 is configured for clamping finished or pre-machined components where marring of the workpiece surface is to be avoided. Because the clamp face 28 is machinable, this modification may be performed directly on the clamp while it is mounted and locked on the machine platform, without disassembly.

In yet another configuration, identified by reference numeral 60 in FIG. 6, the clamp face 28 may be machined to form a contoured face 60. The contoured face 60 is custom-machined to match the geometry of a particular workpiece, thereby increasing the contact surface area between the clamp and the workpiece and providing enhanced stability during machining of irregularly shaped components.

In one method of producing the smooth face 50 or contoured face 60, the operator advances the drive screw 12 to lock the upper slide 16 against the dovetail track of the clamp base 18, rigidly fixing the upper slide 16 in position. In a preferred embodiment, a torque of approximately 5 ft-lbs is applied to secure the upper slide 16 for machining. With the upper slide 16 thus secured, the clamp face 28 may be directly machined using the same CNC equipment on which the clamp is mounted, ensuring precise alignment of the machined face with the workpiece datum.

### Grid Plate and T-Slot Plate—FIG. 10

FIG. 10 illustrates a top view of a grid plate or T-slot plate suitable for use with the compact dovetail clamp of the present invention. The plate includes a pattern of apertures or T-slots configured to receive the mounting screw 14 and to permit 360-degree rotational repositioning of the clamp base 18. The compact dovetail clamp is compatible with both standard T-slot machine tables and grid plates having threaded apertures of appropriate size for the selected mounting screw 14.

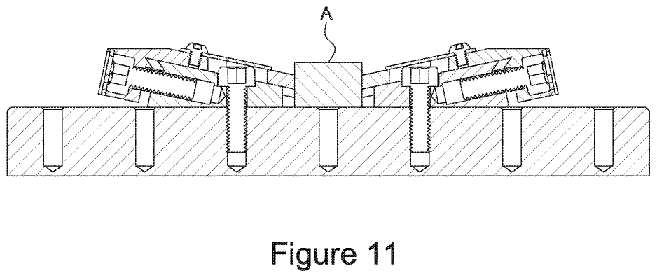

### Dual-Clamp Configuration—FIG. 11

As illustrated in FIG. 11, the compact dovetail clamp may be used in a dual-clamp configuration wherein two clamps are positioned on opposing sides of a workpiece. In this configuration, the workpiece is sandwiched between the clamp faces 28 of the two opposing clamps. The operator may retract the upper slide 16 of one clamp by fully retracting the drive screw 12 so that the clamp face 28 may serve as a hard stop or datum surface, against which the opposing clamp urges the workpiece. The drive screw 12 of each clamp is tightened to apply clamping force from both sides of the workpiece simultaneously, generating downward force on both sides and providing stability and precision location for repeatable operations.

In one operational mode, one clamp may be used as a locator or hard stop, with the front face of its clamp base 18 or its clamp face 28 serving as a fixed datum surface. The opposing clamp is then advanced to urge the workpiece against this datum, precisely locating the workpiece for machining. This bilateral clamping approach is particularly advantageous for high-precision or high-volume production environments, as it allows downward force to be applied to all sides of the workpiece—a capability not available with conventional clamping devices.

### Materials and Variations

In a preferred embodiment, the clamp base 18, upper slide 16, chip shield 22, and associated components are fabricated from 7075-T6 aluminum alloy. This material provides high strength while remaining machinable, enabling the clamp face 28 to be modified by the operator as described herein. For applications requiring greater durability and resistance to deformation under heavier industrial cutting forces, the components may alternatively be fabricated from steel or heat-treated alloys.

In another variation, the clamp face 28 may be configured to accept interchangeable face inserts, enabling the operator to switch among the serrated face 40, smooth face 50, and contoured face 60 configurations without re-machining the entire upper slide 16. This modular insert approach further extends the versatility of the clamping system.

In a further variation, the compact dovetail clamp may be scaled to accommodate different drive screw and mounting screw sizes to suit a wide range of CNC machine sizes and applications. In one embodiment configured for desktop and light-duty CNC machines, the drive screw 12 and mounting screw 14 are M6 fasteners. In embodiments configured for mid-range or large industrial CNC machines, the drive screw 12 and mounting screw 14 may be M12 or M16 fasteners, or other sizes as appropriate. Larger fastener sizes produce proportionally greater clamping forces. In embodiments utilizing M12 or M16 drive screws, the clamping force generated by the compact dovetail clamp may be configured to exceed the cutting forces imposed on the workpiece during machining at maximum machine speed and feed rates. This capability allows machine operators and programmers to develop machining programs based on the capabilities of the cutting tool and the machine, rather than being limited by the holding capacity of the workholding device—a significant departure from conventional clamping practice. The result is the ability to machine workpieces at maximum production rates, reducing cost per part, increasing throughput, and improving overall machine utilization and productivity.

### Operation

In operation, the user positions the compact dovetail clamp adjacent to a workpiece on the machine platform, with the upper slide 16 in the retracted position so that adequate clearance is available for loading and unloading the workpiece. The mounting screw 14 is inserted through the clamp base 18 and engaged with the machine platform. Prior to final tightening of the mounting screw 14, the clamp base 18 may be rotated about the mounting screw 14 to orient the clamping direction as desired. The mounting screw 14 is then tightened using a hex key.

The chip shield 22 is then pivoted to the closed position over the mounting screw 14 and retained by the chip shield retaining plug 24. Using the same hex key, the operator applies torque to the drive screw 12, advancing the upper slide 16 along the dovetail track of the clamp base 18 until the clamp face 28 contacts and applies the desired clamping force to the workpiece. In a preferred embodiment, a torque of approximately 5 ft-lbs (6.5 N·m) is applied during normal workholding operations, not to exceed approximately 10 ft-lbs (13.5 N·m) when used on a grid plate.

Upon completion of the machining operation, the drive screw 12 is loosened. The retaining clip 20 draws the upper slide 16 rearward as the drive screw 12 is retracted, opening the clamping gap and allowing the workpiece to be removed and a new workpiece to be loaded. This process may be repeated rapidly and consistently, supporting efficient production cycles.

The foregoing describes the best currently contemplated embodiments of the invention. Modifications and alternatives will be apparent to those skilled in the art and are intended to fall within the scope of the following claims.

What is claimed is:

1. A compact dovetail clamp comprising:
a clamp base configured to be mounted to a machine platform via a mounting screw, the clamp base having a dovetail track formed therein at a downward angle relative to a clamping direction;
an upper slide movably coupled to the clamp base via the dovetail track;
a drive screw threadedly engaging the clamp base and configured, upon advancement, to urge the upper slide along the dovetail track to simultaneously apply a lateral clamping force and a downward force on a workpiece; and
a clamp face disposed on the upper slide and configured to contact the workpiece.

2. The compact dovetail clamp of claim 1, wherein the clamp face comprises a serrated face configured to grip a rough or raw material workpiece surface.

3. The compact dovetail clamp of claim 1, wherein the clamp face is machinable to produce at least one of a smooth face and a contoured face.

4. The compact dovetail clamp of claim 3, wherein the clamp face is machined while the upper slide is secured in position by advancing the drive screw.

5. The compact dovetail clamp of claim 1, further comprising a retaining clip associated with the drive screw, the retaining clip being configured to retract the upper slide along the dovetail track when the drive screw is loosened.

6. The compact dovetail clamp of claim 1, further comprising a chip shield pivotally mounted to the clamp base and configured to cover the mounting screw to protect the dovetail track from chip contamination during machining operations.

7. The compact dovetail clamp of claim 6, further comprising a chip shield retaining plug configured to retain the chip shield in a closed position over the mounting screw.

8. The compact dovetail clamp of claim 1, wherein the drive screw and the mounting screw are each configured to be actuated by the same tool.

9. The compact dovetail clamp of claim 8, wherein the tool is a hex key.

10. The compact dovetail clamp of claim 1, wherein the clamp base is configured to rotate 360 degrees about the mounting screw to permit clamping force to be applied in any direction across the machine platform.

11. The compact dovetail clamp of claim 1, wherein the machine platform comprises at least one of a T-slot table and a grid plate, and wherein the mounting screw is configured to engage the T-slot table or grid plate.

12. The compact dovetail clamp of claim 1, wherein a front surface of the clamp base is configured to serve as a locating stop for positioning a workpiece on the machine platform.

13. A workholding system comprising:
a first compact dovetail clamp and a second compact dovetail clamp, each comprising:
a clamp base configured to be mounted to a machine platform via a mounting screw;
an upper slide movably coupled to the clamp base through a downward-angled dovetail track;
a drive screw configured to advance the upper slide along the dovetail track to apply a simultaneous downward and lateral clamping force; and
a clamp face disposed on the upper slide;
wherein the first compact dovetail clamp and the second compact dovetail clamp are positioned on opposing sides of a workpiece such that the clamp faces of the first and second compact dovetail clamps engage opposing surfaces of the workpiece.

14. The workholding system of claim 13, wherein a front surface of each clamp base is configured to serve as a locating stop.

15. The workholding system of claim 13, wherein each compact dovetail clamp further comprises a retaining clip configured to retract the upper slide when the drive screw is loosened.

16. The workholding system of claim 13, wherein the drive screw and the mounting screw of each compact dovetail clamp are configured to be actuated by the same tool.

17. A method of clamping a workpiece on a machine platform, the method comprising:
mounting a clamp base of a compact dovetail clamp to the machine platform via a mounting screw, the clamp base including an upper slide movably coupled thereto through a downward-angled dovetail track;
rotating the clamp base about the mounting screw to orient a clamping direction of the compact dovetail clamp relative to the workpiece;
positioning the workpiece adjacent to the clamp base;
advancing a drive screw of the compact dovetail clamp to urge the upper slide along the dovetail track such that a clamp face on the upper slide contacts the workpiece and simultaneously applies a lateral clamping force and a downward force on the workpiece; and
retracting the drive screw after completion of a machining operation to allow removal of the workpiece.

18. The method of claim 17, further comprising pivoting a chip shield over the mounting screw after mounting the clamp base to the machine platform to protect the dovetail track from chip contamination.

19. The method of claim 17, further comprising machining the clamp face while the upper slide is secured in position by the drive screw to produce at least one of a smooth face and a contoured face matched to a geometry of the workpiece.

20. The method of claim 17, further comprising positioning a second compact dovetail clamp on an opposing side of the workpiece and advancing a drive screw of the second compact dovetail clamp to apply clamping force and downward force to the opposing side of the workpiece.
